(19) United States
(12) Patent Application Publication
(10) Pub. No.: US 2025/0172032 A1
(43) Pub. Date: May 29, 2025

(54) BUILDING SECURITY SCREEN ASSEMBLY

(71) Applicant: Crimsafe Security Systems Pty Ltd, Yatala (AU)

(72) Inventors: Peter FERGUSON, Labrador (AU); Michael Adrian SMITH, Aroona (AU)

(73) Assignee: Crimsafe Security Systems Pty Ltd, Yatala (AU)

(21) Appl. No.: 18/960,133

(22) Filed: Nov. 26, 2024

(30) Foreign Application Priority Data
Nov. 27, 2023 (AU) 2023903811

(51) Int. Cl. E06B 3/12; E06B 3/263; E06B 5/11

(52) U.S. Cl. CPC E06B 3/12; E06B 3/263; E06B 5/11

(57) ABSTRACT

The present invention relates to a building security screen assembly. The assembly includes a frame; at least one insert for inserting in the frame; and a security screen for fastening to the insert. Advantageously, the security screen and frame may both include dissimilar metals, and each insert may be electrically non-conductive thereby impeding electrolysis.

### TECHNICAL FIELD

The present invention relates to a security screen assembly for buildings including domestic houses and commercial premises.

The present invention has particular, although not exclusive use for securing windows and doors.

### BACKGROUND

The reference to any prior art in this specification is not, and should not be taken as an acknowledgement or any form of suggestion that the prior art forms part of the common general knowledge.

Security screen assemblies are used to secure the windows and doors of buildings.

A common assembly includes a metal frame, and a metal security screen which is fastened to the metal frame using screws passing through both metals.

Undesirably, electrolysis occurs between the two dissimilar metals.

Embodiments of the present invention provide a security screen assembly which is resistant to electrolysis.

### SUMMARY OF THE INVENTION

According to one aspect of the present invention, there is provided a building security screen assembly including:
a frame;
at least one insert for inserting in the frame; and
a security screen for fastening to the insert.

Advantageously, the security screen and frame may both include dissimilar metals, and each insert may be electrically non-conductive thereby impeding electrolysis. Preferably, the frame and screen do not come into direct contact. Preferably, each insert forms an insulative barrier. In some embodiments, there is no electrical path between the frame and screen.

The frame may include metal. The frame may include aluminum. The security screen may include metal. The screen may include a punched metal sheet. The security screen may include stainless steel. Each insert may not include metal. Each insert may be an electrical insulator. Each insert may be rigid. Each insert may include Polyvinyl Chloride (PVC), Acetal (polyoxymethylene or POM), rubber, ceramic, wood or other like non-conductive material.

The screen may be received in the insert. The screen may be compression fastened within the insert. Optionally, the screen is fastened to each insert using one or more screws. The screws may be 8 g×12 mm pan head woodscrews. Other fixings may include brad nails or a staple fixing. The screen may be slid into the insert during assembly.

The frame may include frame elements. The frame may be rectangular and include four frame elements. Each frame member may receive a respective insert. Each insert may be axially slid into a respective frame member. Each frame member may be integrally formed, and preferably extruded. Each frame member may include a structural or connection portion, and an insert receiver for receiving each insert adjacent the structural or connection portion. The structural or connection portion may be tubular.

Each insert receiver may include one or more retainers for retaining each insert within the frame member. Each retainer may include a pair of protrusions to impede lateral withdrawal of each insert from the frame member. Each insert receiver may include two retainers. One of the retainers may be exposed whereas the other retainer may be concealed within the insert receiver. Each insert receiver may include an opening for receiving the screen. Each insert receiver may be substantially U-shaped.

Each insert may form a snug fit with the retainers. Each insert may define a dock for the screen to be docked in. Each insert may define a stop to stop the screen. Each insert may be pi-shaped. Each insert may include a body from which a pair of legs extend. The body may protrude beyond the legs. Each insert may include a pair of retaining feet protruding from respective legs. The feet may protrude outwardly. The legs may taper inwardly to facilitate insertion of the screen. The insert and frame may define a space there-between. The insert may define at least one outer channel for receiving a fastener. Each insert may be integrally formed, and preferably extruded.

The assembly may be fitted to a building window or door frame.

According to another aspect of the present invention, there is provided a building security screen assembly including:
a frame member;
an insert for inserting in the frame member; and
a security screen for fastening to the insert.

According to another aspect of the present invention, there is provided a method for forming a building security screen assembly, the method including:
fastening a security screen to at least one insert; and
inserting the insert in a frame.

The step of inserting may involve sliding the insert into position within the frame.

The step of fastening may involve sliding the security screen into the insert. The step of fastening may involve screwing the security screen to the insert. The step of screwing may involve screwing a screw to pass through the screen and into the insert. The screw may be screwed to pass through the frame.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an exploded perspective view of a building door security screen assembly in accordance with an embodiment of the present invention;

FIG. 2 is a sectional end view of a frame member of the screen assembly of FIG. 1; and

FIG. 3 is a sectional end view of a frame member of the screen assembly of FIG. 1, with a fastener inserted.

### DETAILED DESCRIPTION OF PREFERRED EMBODIMENTS

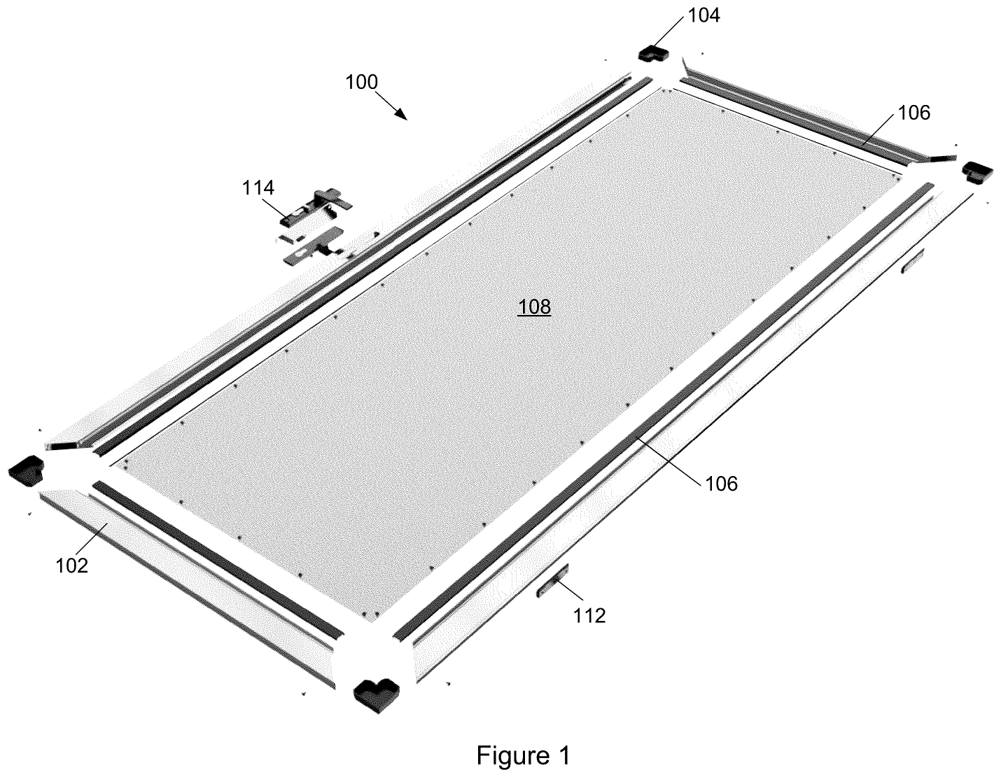

According to an embodiment of the present invention, there is provided a building door security screen assembly 100 as shown in FIG. 1. The security screen assembly 100 includes an outer rectangular frame. The frame is formed by four aluminum frame elements 102 interconnected with four L-shaped corner plugs 104.

Four inserts 106 are axially slid into respective frame elements 102. A security screen 108 is fastened to the inserts 106.

The screen assembly 100 also includes hinges 112 and a handle 114.

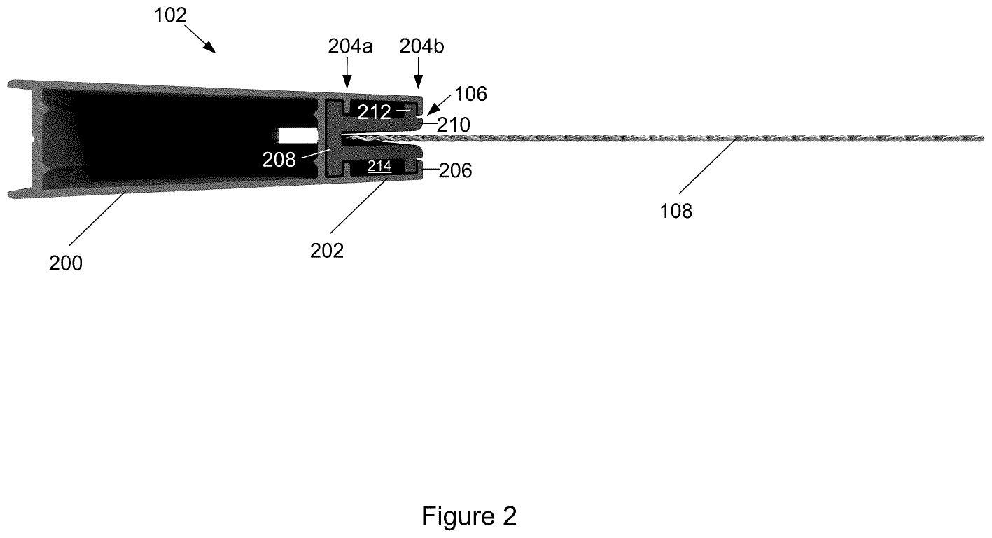

FIG. 2 shows the frame member 102 in greater detail. Advantageously, the security screen 108 and frame elements 102 both include different metals, and the insert 106 is electrically non-conductive thereby impeding electrolysis. The screen 108 includes a punched stainless steel sheet and frame elements 102 are formed from extruded aluminum. The metallic frame elements 102 and screen 108 do not come into direct contact.

The rigid insert 106 does not include metal, and instead is an electrical insulator that forms an insulative barrier. The insert 106 includes Polyvinyl Chloride (PVC), Acetal (polyoxymethylene or POM), rubber, ceramic, wood or other like non-conductive material.

Each frame member 102 is integrally formed, and preferably extruded. Each frame member 102 includes a tubular structural or connection portion 200 which receives the connection plugs 104. Each frame member 102 also includes an insert receiver 202 for receiving each insert 106 adjacent the structural or connection portion 200. The channel or U-shaped insert receiver 202 includes an open mouth for receiving the screen 108.

Each insert receiver 208 includes a concealed retainer 204a and an exposed retainer 204b for retaining each insert 106 within the frame member 102. Each retainer 204 includes a pair of inwardly extending protrusions 206 to impede lateral withdrawal of each insert 106 from the frame member 102. Each insert 106 forms a snug fit within the insert receiver 208 and with the retainers 204a, 204b.

Each insert 106 is also integrally formed, and preferably extruded. Each insert 106 is generally pi-shaped, and includes a body 208 from which a pair of legs 210 extend to define a dock for the screen 108 to docked in. The body 208 protrudes beyond the legs 210 to engage with the concealed retainer 204a. Each insert 106 also includes a pair of retaining feet 212 outwardly protruding from respective legs 210 to engage with the exposed retainer 204b. The free end of the legs 210 are rounded and taper inwardly to facilitate lateral insertion of the screen 108. The body 208 and legs 210 form a crotch stop to stop the sliding screen 108.

The insert 106 defines opposed outer channels so that spaces 214 are defined between the insert 106 and frame 102. Although the screen 108 is received and compression fastened within the insert 106, the screen 108 can be fastened to each insert 106 using one or more screws. The spaces 214 accommodate the heads and/or tails of the screws passing through the insert 106. The screws can be 8 g×12 mm pan head woodscrews.

A method for forming the building security screen assembly 100 is now briefly described.

The method includes fastening the security screen 108 to the inserts 106. The fastening involves laterally sliding the security screen 108 into the inserts 106 and then optionally screwing the security screen 108 to the inserts 106. The screws pass through the inserts 106 and into the screen 108, and may extend right through the inserts 106.

The method also includes inserting the inserts 106 into the frame elements 102 of the frame. In particular, the inserts 106 are axially slid into the frame elements 102. The screws do not contact the frame elements 102 so there is no electrical path between the screen 108 and frame elements 102. However, in an alternative embodiment, the screws can be screwed to pass through the frame, and into the inserts 106 and screen 108.

The method includes forming the rectangular frame by inserting the corner plugs 104 in the frame elements 102.

A person skilled in the art will appreciate that many embodiments and variations can be made without departing from the ambit of the present invention.

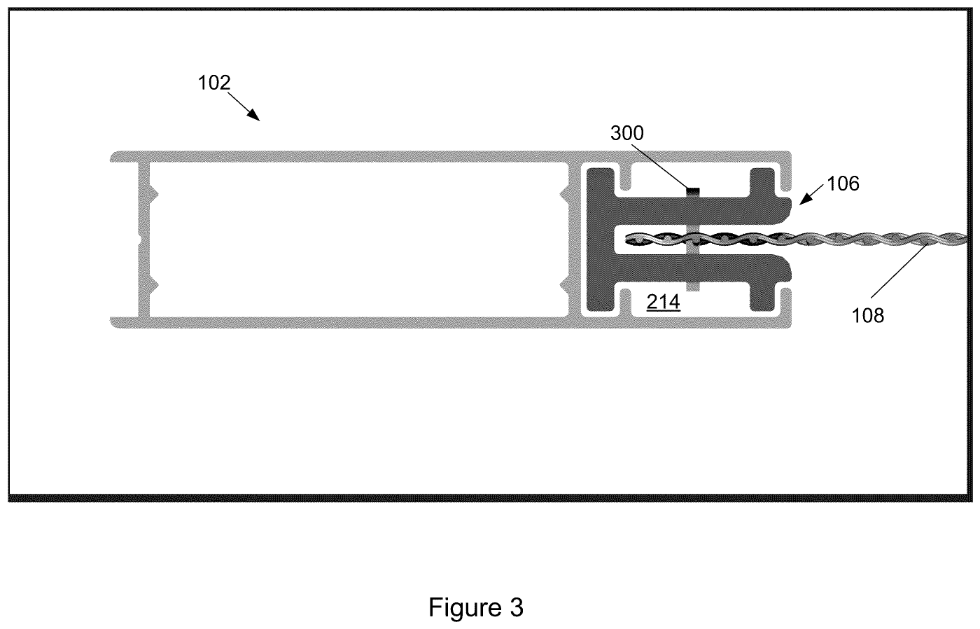

As shown in FIG. 3, the fastener 300 extends through the insert 106 and screen 108, and is located in the spaces 214 without contacting the frame element 102. The fastener 300 can include a screw or other fixings such as a brad nail or a staple fixing.

The assembly 100 can be fitted to a building window or door frame.

In one embodiment, nails can be used instead of screws.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The claims defining the invention are as follows:

1. A building security screen assembly including:
a frame;
at least one insert for inserting in the frame; and
a security screen for fastening to the insert.

2. A building security screen assembly as claimed in claim 1, wherein the security screen and frame include dissimilar metals, and each insert is electrically non-conductive thereby impeding electrolysis.

3. A building security screen assembly as claimed in claim 1, wherein the frame and screen do not come into direct contact.

4. A building security screen assembly as claimed in claim 1, wherein each insert forms an insulative barrier.

5. A building security screen assembly as claimed in claim 1, wherein there is no electrical path between the frame and screen.

6. A building security screen assembly as claimed in claim 1, wherein the frame includes metal, the screen includes a punched metal sheet, and each insert is an electrical insulator.

7. A building security screen assembly as claimed in claim 1, wherein the screen is received in the insert, and preferably slid into the insert during assembly.

8. A building security screen assembly as claimed in claim 1, wherein the screen is compression fastened within the insert or is fastened to each insert using one or more fasteners.

9. A building security screen assembly as claimed in claim 1, wherein the frame includes frame elements, each frame member receiving a respective insert axially slid into a respective frame member.

10. A building security screen assembly as claimed in claim 1, wherein each frame member includes a structural or connection portion, and an insert receiver for receiving each insert adjacent the structural or connection portion.

11. A building security screen assembly as claimed in claim 10, wherein the structural or connection portion is tubular.

12. A building security screen assembly as claimed in claim 10, wherein each insert receiver includes one or more retainers for retaining each insert within the frame member.

13. A building security screen assembly as claimed in claim 12, wherein each retainer includes a pair of protrusions to impede lateral withdrawal of each insert from the frame member.

14. A building security screen assembly as claimed in claim 12, wherein each insert receiver includes two retainers wherein one of the retainers is exposed whereas the other retainer is concealed within the insert receiver.

15. A building security screen assembly as claimed in claim 1, wherein each insert forms a snug fit with the retainers, each insert defining a dock for the screen to be docked in, each insert defining a stop to stop the screen and/or each insert is pi-shaped.

16. A building security screen assembly as claimed in claim 1, wherein each insert includes a body from which a pair of legs extend, the body protruding beyond the legs, each insert including a pair of retaining feet protruding from respective legs, the feet protruding outwardly and/or the legs tapering inwardly to facilitate insertion of the screen.

17. A building security screen assembly including:
a frame member;
an insert for inserting in the frame member; and
a security screen for fastening to the insert.

18. A method for forming a building security screen assembly, the method
including: fastening a security screen to at least one insert; and
inserting the insert in a frame.

19. A method for forming a building security screen assembly as claimed in claim 18, wherein the step of inserting involves sliding the insert into position within the frame.

20. A method for forming a building security screen assembly as claimed in claim 18 wherein the step of fastening involves sliding the security screen into the insert and screwing the security screen to the insert.
